(19) United States
(12) Patent Application Publication
(10) Pub. No.: US 2021/0279669 A1
(43) Pub. Date: Sep. 9, 2021

(54) HYBRID HUMAN-COMPUTER LEARNING SYSTEM

(71) Applicant: Anthrop LLC, Austin, TX (US)

(72) Inventor: Richard GARDNER, Scottsdale, AZ (US)

(73) Assignee: Anthrop LLC, Austin, TX (US)

(21) Appl. No.: 16/836,749

(22) Filed: Mar. 31, 2020

Related U.S. Application Data
(60) Provisional application No. 62/986,525, filed on Mar. 6, 2020.

(51) Int. Cl. G06Q 10/06; G06N 20/00

(52) U.S. Cl. CPC G06Q 10/063112; G06N 20/00

(57) ABSTRACT

A human-computer hybrid learning system may include an interconnected series of layers of nodes, where each node includes a communication device associated with a human expert. A task introduced into the first layer may be assessed and solved individually by experts of the first layer, and the solutions may be assessed and ranked by following layers. The system may automatically control selection of experts, communication between nodes, and generation of a final solution based on the results.

### CROSS-REFERENCES

This application claims the benefit under 35 U.S.C. § 119(e) of the priority of U.S. Provisional Patent Application Ser. No. 62/986,525, filed Mar. 6, 2020, the entirety of which is hereby incorporated by reference for all purposes.

### INTRODUCTION

Expert systems are computer systems programmed to emulate reasoning tasks by interpreting the encoded knowledge of human experts. Existing expert systems are static, offline systems designed to be updated with expert knowledge once or periodically. These expert systems typically utilize static databases of recorded expert knowledge to recommend decisions and provide advice in areas such as medical diagnosis, stock trading, evaluation of art, music, or movies, and/or other subjective or objective areas.

Some examples of existing expert systems attempt to encode unstructured or unarticulated knowledge into a machine-readable format, emulate human emotions and subjective reasoning, and further attempt to process that knowledge into actionable insights in real-time. Utilizing existing solutions, the extraction of knowledge from human experts and encoding that knowledge into a machine-readable format is nearly impossible to perform in real-time due to the complex, tedious, and time-consuming nature of existing expert systems. Thus, existing systems typically fail to have accurate, up-to-date expert opinions for any topic.

### SUMMARY

The present disclosure provides systems, apparatuses, and methods relating to expert learning systems, and addresses one or more of the shortcomings of known expert systems described above.

In some embodiments, a data processing system for providing a solution to a user-supplied task may include: a memory, one or more processors, and a plurality of instructions stored in the memory and executable by the one or more processors to: receive task-related data corresponding to a selected task, wherein the task is identified with a selected domain of one or more domains of expertise; from a plurality of experts, automatically select a first subset of experts associated with the selected domain and a second subset of experts associated with the selected domain; communicate the task-related data to a plurality of first electronic devices, wherein each of the first electronic devices is associated with a respective one of the experts of the first subset; receive from each of the experts of the first subset, via the first electronic devices, a respective task solution and an accompanying first confidence score; generate a first set of task solutions based on the task solutions received from the experts of the first subset, sorted by the first confidence scores; communicate the task-related data and the first set of task solutions to a plurality of second electronic devices, wherein each of the second electronic devices is associated with a respective one of the experts of the second subset; receive from each of the experts of the second subset, via the second electronic devices, information indicating a respective selected solution chosen from the first set of task solutions and an accompanying second confidence score; generate a second set of task solutions based on the information indicating the selected solutions, sorted by the second confidence scores; generate a preliminary output based on the second set of task solutions; and communicate a final output based on the preliminary output to a user interface.

In some embodiments, a data processing system for providing a solution to a user-supplied task may include: a memory; one or more processors; a plurality of instructions stored in the memory and executable by the one or more processors to: receive task-related data corresponding to a selected task, wherein the task is identified with a selected domain of one or more domains of expertise; from a plurality of experts, automatically select a first subset of experts, one or more intermediate subsets of experts, and a final subset of experts, wherein each of the subsets of experts is associated with the selected domain; communicate the task-related data to a plurality of first electronic devices, wherein each of the first electronic devices is associated with a respective one of the experts of the first subset; receive from each of the experts of the first subset, via the first electronic devices, a respective task solution and an accompanying first confidence score; generate an intermediate set of task solutions based on the task solutions received from the experts of the first subset, sorted by the first confidence scores; with respect to each of the one or more intermediate subsets, in series: communicate the task-related data and the intermediate set of task solutions to a plurality of electronic devices, wherein each of the electronic devices is associated with a respective one of the experts of the respective intermediate subset; receive from each of the experts of the respective intermediate subset, via the electronic devices, information indicating a respective selected solution chosen from the intermediate set of task solutions and an accompanying intermediate confidence score; and update the intermediate set of task solutions based on the information indicating the selected solutions, sorted by the intermediate confidence scores; communicate the intermediate task-related data to a plurality of final electronic devices, wherein each of the final electronic devices is associated with a respective one of the experts of the final subset; receive from each of the experts of the final subset, via the final electronic devices, information indicating a respective selected solution chosen from the intermediate set of task solutions and an accompanying final confidence score; and communicate, to a user interface, a final set of task solutions based on the information indicating the selected solutions.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram of an illustrative neural network model.

FIG. 2 is a schematic diagram of an illustrative learning system in accordance with aspects of the present disclosure.

FIG. 3 is a schematic diagram of the learning system of FIG. 2, further depicting an input layer, hidden layer(s), and an output layer.

FIG. 4 is a schematic diagram of a node of the learning system of FIG. 2, in accordance with aspects of the present disclosure.

FIG. 5 is schematic diagram of a data flow of the learning system of FIG. 2.

FIG. 6 is a schematic diagram of the input layer of FIG. 3.

FIG. 7 is a schematic diagram of the hidden layer(s) of FIG. 3.

FIG. 8 is a schematic diagram of the output layer of FIG. 3.

FIG. 9 is a flow chart depicting steps of an illustrative method of operation of a task server in accordance with aspects of the present disclosure.

FIG. 10 is a flow chart depicting steps of an illustrative method of training a learning system in accordance with aspects of the present disclosure.

FIG. 11 is a schematic diagram of an illustrative data processing system in accordance with aspects of the present disclosure.

FIG. 12 is a schematic diagram of an illustrative distributed data processing system in accordance with aspects of the present disclosure.

### DETAILED DESCRIPTION

Various aspects and examples of a learning system (or expert system) are described below and illustrated in the associated drawings. Unless otherwise specified, learning systems in accordance with the present teachings, and/or their various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections A through F, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Processing logic” describes any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (Al) accelerators, digital signal processors (DSPs), and/or any other suitable combination of logic hardware.

A “controller” or “electronic controller” includes processing logic programmed with instructions to carry out a controlling function with respect to a control element. For example, an electronic controller may be configured to receive an input signal, compare the input signal to a selected control value or setpoint value, and determine an output signal to a control element (e.g., a motor or actuator) to provide corrective action based on the comparison. In another example, an electronic controller may be configured to interface between a host device (e.g., a desktop computer, a mainframe, etc.) and a peripheral device (e.g., a memory device, an input/output device, etc.) to control and/or monitor input and output signals to and from the peripheral device.

“Providing,” in the context of a method, may include receiving, obtaining, purchasing, manufacturing, generating, processing, preprocessing, and/or the like, such that the object or material provided is in a state and configuration for other steps to be carried out.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

In general, hybrid human-computer learning systems of the present disclosure provide an architectural framework for experts to analyze questions and/or problems (e.g., tasks) submitted by a user. The system enables subjective and objective answers to be aggregated from a plurality of responses provided by the experts, while providing improved performance in terms of speed, accuracy, and cost (e.g., time, money, etc.). For example, a healthcare practitioner may utilize the system to receive a medical diagnosis for a rare or complex medical condition through a network of doctors.

The learning systems of the present disclosure utilize a network modeled after a deep learning, recurrent neural network, and utilize experts to solve subjective and challenging problems. The learning system may provide solutions that would otherwise be impossible for computers to solve via known methods. As with a standard neural network, the system may also be used for predictive modeling.

The learning system is configured to enable one or more proficient experts to provide unique solutions to a proposed task, with accompanying confidence scores and, in response, submit those solutions to a voting group of experts. Each expert in the voting group selects a correct or most correct choice from the provided solutions, based on their expert opinion, and provides their own confidence score for the selection. Further layers and/or various examples of layer sequencing may be utilized, and the system is configured to output an answer, e.g., in the form of a list of solutions sorted by confidence.

Aspects of the learning system may be embodied as a computer method, computer system, or computer program product. Accordingly, aspects of the learning system may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the learning system may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable non-transitory, tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of the learning system may be written in one or any combination of programming languages, including an object-oriented programming language (such as Java, C++), conventional procedural programming languages (such as C), and functional programming languages (such as Haskell). Mobile apps may be developed using any suitable language, including those previously mentioned, as well as Objective-C, Swift, C#, HTML5, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the learning system may be described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be programmed into or otherwise provided to processing logic (e.g., a processor of a general purpose computer, special purpose computer, field programmable gate array (FPGA), or other programmable data processing apparatus) to produce a machine, such that the (e.g., machine-readable) instructions, which execute via the processing logic, create means for implementing the functions/acts specified in the flowchart and/or block diagram block(s).

Additionally or alternatively, these computer program instructions may be stored in a computer-readable medium that can direct processing logic and/or any other suitable device to function in a particular manner, such that the instructions stored in the computer-readable medium produce an article of manufacture including instructions which implement the function/act specified in the flowchart and/or block diagram block(s).

The computer program instructions can also be loaded onto processing logic and/or any other suitable device to cause a series of operational steps to be performed on the device to produce a computer-implemented process such that the executed instructions provide processes for implementing the functions/acts specified in the flowchart and/or block diagram block(s).

Any flowchart and/or block diagram in the drawings is intended to illustrate the architecture, functionality, and/or operation of possible implementations of systems, methods, and computer program products according to aspects of the learning system. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### Examples, Components, and Alternatives

The following sections describe selected aspects of illustrative learning systems as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Hybrid Human-Computer Learning System

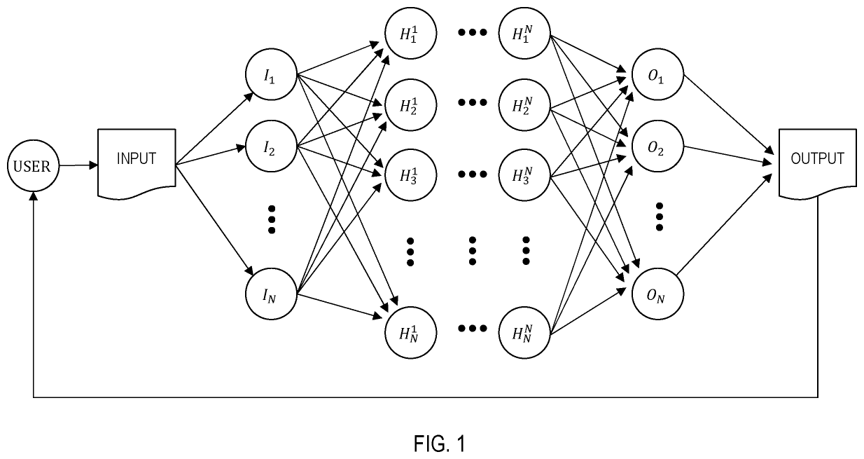

As shown in FIGS. 1-3, this section describes an illustrative hybrid human-computer learning system 100, an example of the learning system described above.

Learning system 100 uses a framework similar in construction and functionality to a neural network to orchestrate and perform the tasks. In general, a neural network is a computing system inspired by and analogous to biological neural networks, e.g., found in the brains of animals. Such systems consider examples of tasks and learn to solve such tasks by training to reach known solutions to those examples, generally without task-specific rules. Some neural network systems can learn autonomously in an unsupervised manner without examples, e.g., by deriving conclusions from a complex and seemingly unrelated set of information.

With respect to FIG. 1, a neural network is typically based on a collection of connected units (commonly referred to as nodes or neurons), which may loosely model the neurological structure of a biological brain. Each connection, like the synapses in a biological brain, can transmit a signal to other nodes. A node that receives a signal then processes it and can signal nodes connected to it.

Nodes are typically arranged or aggregated into layers; for example, an input layer comprising input nodes labeled I₁ through I_{N}, one or more hidden layers including a first hidden layer comprising first hidden nodes labeled H¹₁ through H¹_{N}, and an output layer comprising output nodes labeled O₁ through O_{N}. An input signal is supplied, e.g., by a user, to each input node of the input layer. The signal is processed by each the nodes in the input layer before traveling to each of the nodes of the first hidden layer. This signal propagation and processing may continue through the network to the final output layer. The output layer contains one or more nodes that, after processing the signal, output one or more signals as a final output. The output may be provided to the user. Additionally, or alternatively, the output may be fed into the system again, i.e., as an input. If the signals traverse the layers multiple times (such as from the output back to the input), learning system 100 may be referred to as a recurrent neural network. Additionally, if the neural network contains multiple hidden layers, it is referred to as “deep,” e.g., as in the term Deep Learning.

In a typical neural network implementation, the signal propagated through each node connection is a real number. Each node computes an aggregation of its inputs, e.g., utilizing a non-linear, differentiable function (AKA activation function) on the sum of its inputs. In some examples, the activation function is monotonic and sigmoidal. In many neural network implementations, each node has an associated weight. Typically, each weight value is a real number. Weights may represent the respective node's effective influence or strength in the network. For example, during processing, a node may multiply its real number input by its associated weight when calculating an output. Nodes with a higher weight may influence the overall output of the network more than nodes with a lower weight. While some neural networks can learn autonomously (e.g., unsupervised learning), other neural networks must be trained (e.g., with labeled datasets) to update the weights or modify the network architecture in order to create an optimal mapping of inputs to outputs (e.g., supervised learning). Training a neural network may include the use of an optimization algorithm (e.g., backpropagation) to find an optimal or quasi-optimal set of weights.

Training of the network is not required for learning system 100 to function, as experts are selected to perform tasks based on prior experience. However, network training using data with known outcomes as target values may be utilized to improve performance and/or accuracy for certain networks and tasks (e.g., those that require research and/or learning). A more detailed description of training the learning system is described in more depth in section C below.

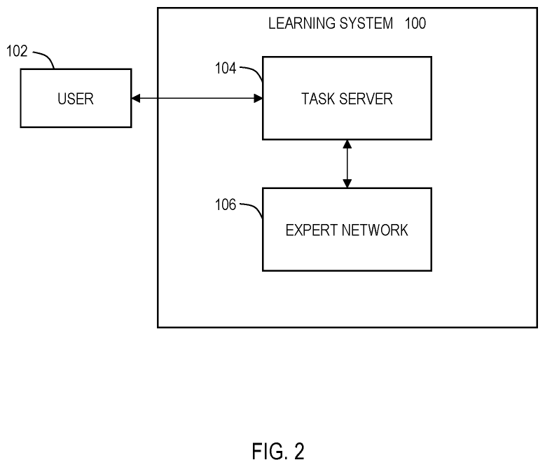

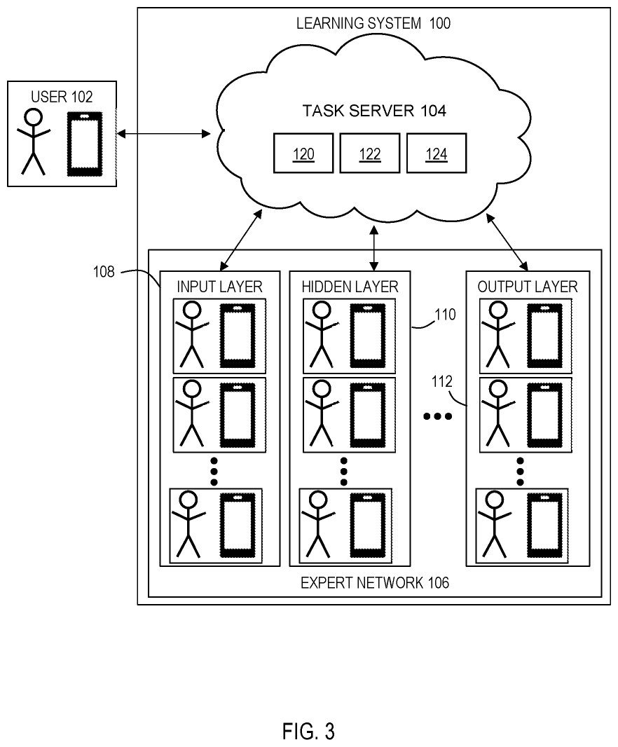

Turning to FIGS. 2 and 3, learning system 100 utilizes an expert network 106 having a neural network architecture, in which each node of the network comprises an expert and an accompanying device. The signal propagated through each node connection is a qualitative and/or quantitative analysis provided by the expert of the preceding node.

A user 102 communicates with learning system 100 via a task server 104. Task server 104 is an example of a data processing system (see section D below). Task server 104 includes a memory device having a database having task data 120, expert data 122, and network data 124. All information stored in the database may be encrypted/obfuscated to ensure the best security practices.

Task data 120 may include any data pertaining to the task, including, for example, a description of the task (e.g., questions, descriptions, media—pictures, video, etc., area of expertise suitable for the task, and/or any other additional information pertinent to the task). In some examples, task data 120 includes a maximum task time limit. In some examples, the task time limit may have a default value of 5 minutes. This may be helpful for time-sensitive tasks (e.g., a medical diagnosis), as all experts in a specific layer may need to respond before the network error can be calculated, weights adjusted, and the output propagated.

In some examples, task data 120 includes a reward description. A reward may be paid to experts based on accuracy and/or responsiveness, among other factors. Depending on the reward, experts may be rewarded less (or not at all) if tasks are not completed in a timely manner, or if tasks do not contain certain information such as references if appropriate, or for various other reasons. Additionally, or alternatively, rewards may be provided to individual experts or groups of experts. Additionally, or alternatively, rewards may be requested by user 102, allowing the experts to pay to participate in a task.

Expert data 122 may include any suitable data pertaining to the experts, including, a unique ID for each expert, a categorical description of each expert's expertise (e.g., medicine, music, law, etc.), and/or historical data pertaining to previous task solutions each expert may have provided.

In some examples, expert data 122 includes a weight value associate with each expert. In learning system 100, the weights may represent the speed and accuracy of past results/performances. As in the description above, the weights in learning system 100 represent the effective influence or strength in expert network 106. The expert's weights may be utilized by learning system 100 to amplify or dampen an input and increase or decrease the strength of the signal at the connection, thereby assigning significance to inputs with regard to the task the algorithm is trying to learn.

Expert data 122 may additionally include a confidence level associated with each expert. Experts may rate the confidence level of their own outputs, for example, a value between −1 to 1, 0 to 1, 1 to 100, or by a number of stars, or another rating system. If the confidence level is too low, the output may not propagate to other nodes in the network (see description of Activation Threshold below). Additionally, in some embodiments, experts rate other experts' outputs.

In some examples, task server 104 utilizes expert data 122 to categorize the experts based on, for example, expertise, demographics, accuracy, availability, response time, cost, etc., such that a network configuration may be determined and stored in network data 124. In this manner, a network of registered, on-call experts is created and maintained by learning system 100.

In some examples, network data 124 includes a Learning Rate value for adjusting weights, e.g., during a training process. In some examples, Learning Rate has a default value of 0.25%. Network errors are multiplied by the Learning Rate and weights are adjusted accordingly. In some embodiments, learning system 100 utilizes simulated annealing, wherein the Learning Rate is decreased as a training dataset is processed.

In some examples, network data 124 includes a Maximum Reentry value that denotes the maximum number of times the network can feed outputs back into the inputs of the network (i.e., epochs). The feeding of the outputs back into the inputs may assist the network in forming a consensus (i.e., converging). In some examples, the Maximum Reentry value may have a default of 2 epochs.

In some examples, network data 124 includes a Minimum Comment value delineating the minimum number of characters that must be typed into a note section by each expert before propagating their output to the next layer. In some examples, the Minimum Comment value has a default of 20 characters. The Minimum Comment value may encourage experts to contribute more to their output and the overall task solution. The comment may contain references supporting their output.

In some examples, network data 124 includes an Activation Threshold. If an expert ranks their own confidence level below the Activation Threshold, their output may not propagate (e.g., may be prevented from propagating) to the next layers of experts. The Activation Threshold may be set to any value between 0% to 100%, and in some examples may have a default value of 0.1%. If no other outputs from other experts located in the same layer are available to send to the next layer, then the Activation Threshold may be ignored, and the output may be sent to the next layer.

In some examples, network data 124 includes a Replacement Rate. Experts who provide erroneous outputs or have low weights due to poor performance may be automatically replaced by learning system 100. The Replacement Rate specifies a probability that an expert may be replaced. In some examples, the Replacement Rate may have a default value of 0.1%. The weights of all experts in the network may be normalized between 0 and 1, and if a specific expert has a weight less than the Replacement Rate, the expert may be removed and replaced with another expert (i.e., one who may provide a more accurate result).

Before a task is processed by expert network 106, each expert may be grouped into an input layer 108, a hidden layer 110, or an output layer 112. Experts may be chosen and grouped automatically/dynamically by task server 104, and/or experts may be specified by the user. Experts may be ranked by their weight, which may be derived from the accuracy of their previous outputs. Experts with the highest weights may be placed higher (i.e., earlier) in the network while those with lower weights may be placed lower (i.e., later) in the network. Certain layers of the learning system may operate by layer-specific rules as described in more depth below. In the current example, a single hidden layer is discussed for brevity and simplicity, though learning system 100 may alternatively utilize an expert network having more or fewer hidden layers.

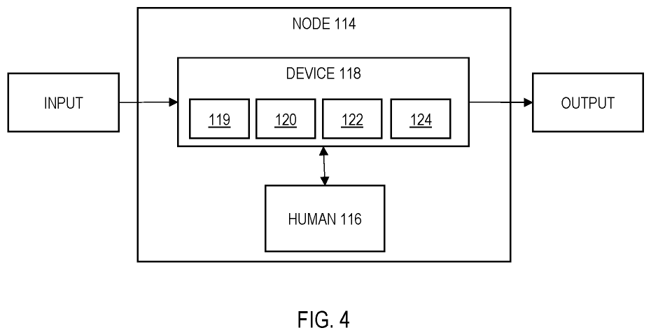

Turning to FIG. 4, user 102 and each expert in expert network 106 is an example of a general node 114 of the network. Each node 114 comprises a device 118 in communication with a human 116 (either a user or an expert). In some embodiments, device 118 is a smartphone. In some embodiments of learning system 100, device 118 includes a desktop computer or laptop computer. Device 118 is configured to receive inputs and provide outputs to task server 104. Communication between human 116 and device 118 may be accomplished using any suitable human-machine interface (HMI), for example, using a graphical user interface (GUI). Device 118 may have data for operation stored thereon, such as task data 120, expert data 122, and network data 124. In some examples, devices of certain nodes have partial data stored thereon, for example, certain expert nodes may only have task data stored on their device.

Some embodiments of learning system 100 utilize an app 119 (i.e., a software application) installed on device 118. App 119 is configured to enable human 116 to register as an expert to participate in solving tasks. In some examples, app 119 is configured to enable human 116 to register as a user, e.g., to submit their own tasks. Through the use of app 119, experts may receive alerts, push notifications, text messages, and/or the like that provide notification of new tasks for participation (e.g., in return for a fee). In some examples, app 119 is configured to enable user 102 to capture photos or videos on device 118, e.g., to submit with new tasks.

Human 116 may optionally share availability and location information, e.g., anonymously. This option may be disabled by default, and, if intentionally enabled by human 116, device 118 may record locations visited by human 116, with associated timestamps. In some examples, this location data may be utilized to assist law enforcement, for example in solving crimes or finding missing persons.

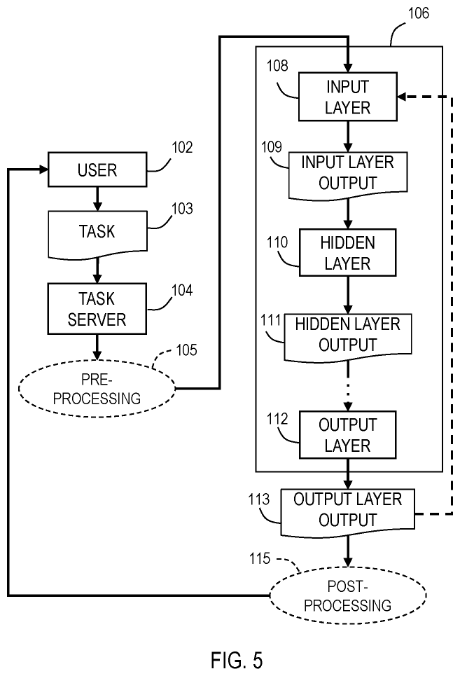

Turning to FIG. 5, user 102 submits task 103 (and associated task data 120 described above) to task server 104. After task 103 is received by task server 104, the task server estimates the cost and time for completion of the task. Task server 104 may attempt to contact each expert's device (such as via push notifications, text messages, emails, etc.) and identify specific experts who are currently available (or who may become available) to participate in the current expert network. Task server 104 then optionally may perform a preprocessing operation 105 on task 103. Otherwise task 103 is dispatched to expert network 106.

When utilized, preprocessing 105 is configured to tailor learning system 100 for a specific domain or field of expertise. In one example, preprocessing 105 may be utilized to assist music artists with receiving feedback for their music. In this example, preprocessing 105 may entail compressing or splitting audio files or performing genre and style classification, artist identification, or performing acoustic analysis prior to submitting the files and tasks. In another example, preprocessing 105 may utilize a Natural Language Processing (NLP) module on news articles and analyst opinions for stocks or other securities. In this example, portions of text may be submitted to learning system 100 for semantic analysis in order to receive a consensus of whether or not the price of a stock should go up or down. In yet another example, preprocessing 105 may be utilized by healthcare professionals to enable patient healthcare data to be ingested by expert system 106 for analysis, e.g., to provide a medical diagnosis. In this example, the expert network may consist of healthcare professionals who are trained and knowledgeable about a specific medical condition or the patient symptoms in question. This configuration may be utilized in emergency medicine, collaborative medical research, and others.

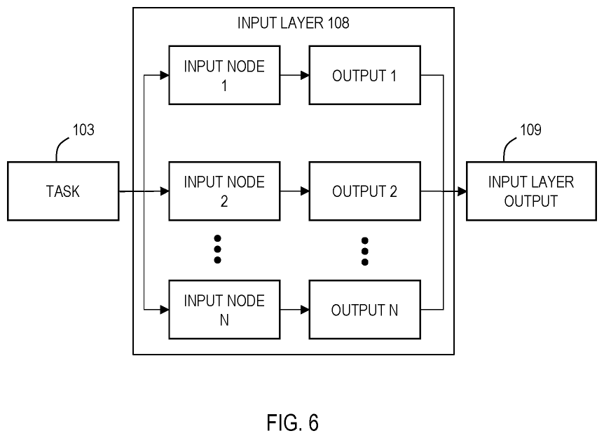

As shown in FIGS. 5 and 6, input layer 108 receives task 103 from task server 104. As shown in FIG. 6, each expert in input layer 108 (labeled input node 1 through N) receives a task 103 from task server 104 via the corresponding device and is allowed a specific amount of time to process and submit a solution as specified by the Task Time Limit. Each expert in input layer 108 provides a unique and subjective solution to task 103, along with an associated confidence level as an output. For example, experts in the first layer may provide outputs represented as text, drawings, photos, videos, recordings, calculations, forecasts, computer files, and/or any other information that might constitute a solution.

Some or all of the outputs from each expert in input layer 108 are aggregated into an output 109 of the input layer. For example, the outputs from each expert in input layer 108 may be compiled into a list of solutions sorted by the confidence level provided by each expert. Input layer output 109 and task 103 are then sent to hidden layer 110. Outputs from one layer to the next may be transmitted either via task server 104 or, alternatively, directly to the experts in the subsequent layer.

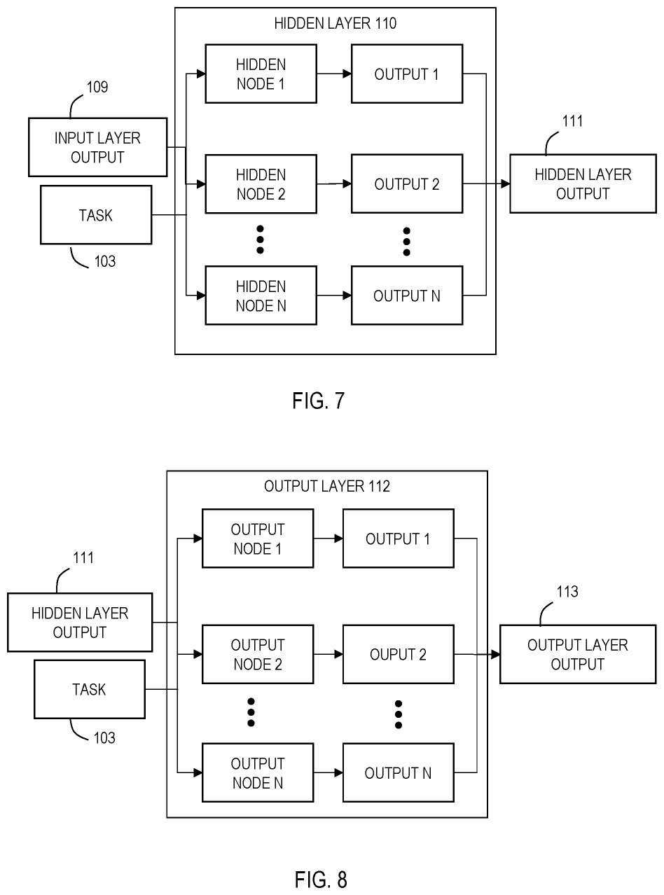

As shown in FIGS. 5 and 7, hidden layer 110 receives input layer output 109 and task 103. Each node in hidden layer 110 (labeled as hidden nodes 1 through N) receives input layer output 109 and task 103 (i.e., at the associated devices). In some examples, nodes in the hidden layer may not receive every solution from input layer 108. For example, solutions that were assigned a confidence level lower than the Activation Threshold may not be included in output 109. Each expert in hidden layer 110 may select from the solutions provided in output 109 of the input layer, and likewise assign a confidence level associated with the selection. The selection and associated confidence level form an output from each node in the hidden layer. In some examples, one or more experts in hidden layer 110 are permitted or expected to choose multiple solutions and provide an accompanying confidence level for each choice.

Some or all of the outputs from each node in hidden layer 110 are aggregated into an output 111 of the hidden layer. For example, the outputs from each node in hidden layer 110 may be compiled into a list of selected solutions sorted by the confidence level provided by each hidden layer expert. Hidden layer output 111 is sent to output layer 112. In examples having multiple hidden layers, the first hidden layer output is sent to a second hidden layer for similar processing. This may continue until every hidden layer has processed task 103.

As shown in FIGS. 5 and 8, output layer 112 receives hidden layer output 111 and task 103. Each node in output layer 112 (labeled output node 1 through N) receives hidden layer output 111 and task 103 via the associated device. In some examples, nodes in the output layer may not receive all solutions from hidden layer 110. For example, solutions that were assigned a confidence level lower than the Activation Threshold may not be included in hidden layer output 111. Each expert in output layer 110 may select from the solutions provided in hidden layer output 111 and likewise assign a confidence level associated with their selection. The selection and associated confidence level form a final output from each node in the output layer. In some examples, one or more experts in output layer 112 may be permitted or expected to choose multiple solutions and provide an accompanying confidence level for each choice.

Some or all of the outputs from each node in output layer 112 are aggregated into an output 113 of the output layer. In some examples, confidence scores may be aggregative. In other words, the confidence scores supplied by each expert for a given solution may be cumulative, averaged, and/or otherwise combined.

In some examples, output layer output 113 includes a single list of solutions ranked by confidence. In some examples, output layer output 113 includes additional listed results ranked by confidence. For example, hidden layer output 111 may be combined with output layer output 113.

Returning to FIG. 5, postprocessing 115 may be applied to output layer output 113 before being provided to user 102. When utilized, postprocessing 115 is configured to tailor the output of expert system 104 for a specific domain or field of expertise. In one example, postprocessing 115 may assist music artists with determining the commercial viability of a song. In another example, postprocessing 115 may assist investors with buying and selling stocks and/or other securities and/or managing their positions. In yet another example, postprocessing 115 may inform doctors of available treatment options based on a diagnosis received from expert network 104.

Preprocessing 105 and postprocessing 115 enable experts to further process or transform data during network operation. For example, if an expert is analyzing music, the expert may run one or more provided software utilities to analyze or transform an audio file to complete the task.

In examples where the network is recurrent, output layer output 113 is fed back into input layer 108 along with task 103 (see Maximum Reentry above). If the network is recurrent, to determine if it is appropriate to send the final outputs back to the first layer, the number of outputs and variations of results may be analyzed.

In some examples, the expected number of final outputs is determined by max (1, Input layer expert count/total expert count in network)*input layer expert count. If the final number of outputs is greater than what is expected, and if the network has not been cycled more than the Maximum Reentry setting, the network reprocesses the outputs.

If the outputs are fed back to input layer 108, an original solution provided by a given node may not be fed back to that node, unless additional notes, comments, references or other data have been added or modified by other experts for reconsideration.

If experts do not respond before the Task Time Limit, the network may continue without their response. If an expert provides a response at a later time, and the network is still running in recurring network operation at that point in time, the output may be propagated in the next pass of the network.

With each cycle through the network, weights are adjusted and optionally saved. In some examples, the nodes are rearranged as part of the competitive learning process. For example, re-ordering of the network layout by task server 104 may occur after each cycle/epoch of the network.

An error in learning system 100 may be calculated in one or more ways depending on whether learning system 100 is training or not. For error calculation during training, see section C below. In some examples, several error calculations may be utilized by learning system 100 in concert and/or sequentially.

In some examples, errors in learning system 100 are identified by confidence-ranking all experts assigned to outputs. If an average of all confidence scores for all outputs is below 50% (i.e., if the overall confidence in the final solutions is low), then subtract the difference from all weights. If the average is above 50%, add the difference to all weights. (e.g., (1−0.5)*learning rate).

In some examples, errors in learning system 100 are identified by comparing the number of final outputs to the number of expected outputs. When the number of outputs is greater than the number of expected outputs, the network did not converge. When the network did not converge, a compensation percentage may be subtracted from all weights. Otherwise the compensating percentage may be added to all weights.

After the weights have been updated and the network has been rearranged, learning system 100 may optionally remove and replace n% of the lowest weighted expert(s) if below the specified Replace Rate. The replace rate may be compared to normalized (e.g., 0-1) values of all current weights. Additionally, after the weights have been updated, each expert's weight may be updated in expert data 122 (in some examples, multiple weights may be stored for each expert, one for each unique task).

In some examples, the final network configuration is saved in network data 124. For example, one or more of the settings may be saved (e.g., expert IDs, accuracy counter values, etc.) to facilitate loading and/or reconstructing the same or similar network again at a later point in time.

In some examples, weights are not utilized. Instead, experts may be removed altogether and/or replaced with other experts who provide more accurate results (e.g., if the original experts' outputs are erroneous).

If weights are not used, the Learning Rate may be utilized to determine the cutoff threshold at which an expert is replaced. In some examples, the replacement of an expert is determined be the expert's contribution to the overall network error.

In some example, a network not utilizing weights utilizes Confidence rankings of all experts assign to all outputs. For example, if all confidence scores for all outputs are below an average of 50%, then subtract the difference from all accuracy counters. If above 50%, then add the difference to all accuracy counters: (1−0.5)*learning rate.

In some examples, a network not utilizing weights compares the number of final outputs to the number of expected outputs. If the number of outputs is greater than the number of expected outputs (i.e., if the network did not converge), then subtract a percentage from all accuracy counters, otherwise add.

After the accuracy counters have been updated, each expert's accuracy counter may be used to determine if the expert should be removed from the network. Learning system 100 may optionally remove and replace n% of the expert(s) if an expert's accuracy counter is below the Replace Rate. The Replace Rate is compared to normalized (e.g., 0-1) values of all current accuracy counters. This process is repeated for each pass through the recurrent network, allowing learning system 100 to learn and improve while in progress, or self-adapt without using weights, (such as with unsupervised learning).

### B. Illustrative Method for Operation of Task Server

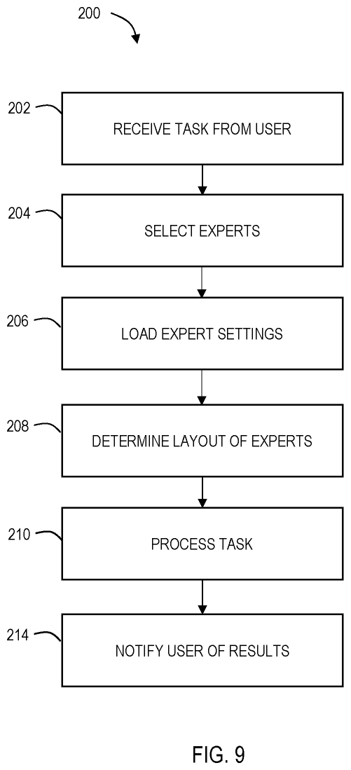

This section describes steps of an illustrative method 200 for operation of a task server of the present disclosure, for example task server 104 of learning system 100 described above; see FIG. 9. Aspects of the learning system described above may be utilized in the method steps described below. Where appropriate, reference may be made to components and systems that may be used in carrying out each step. These references are for illustration, and are not intended to limit the possible ways of carrying out any particular step of the method.

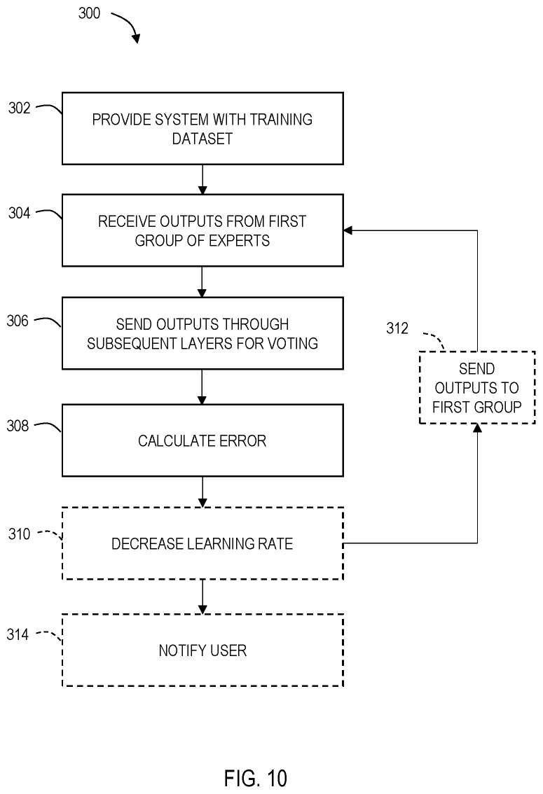

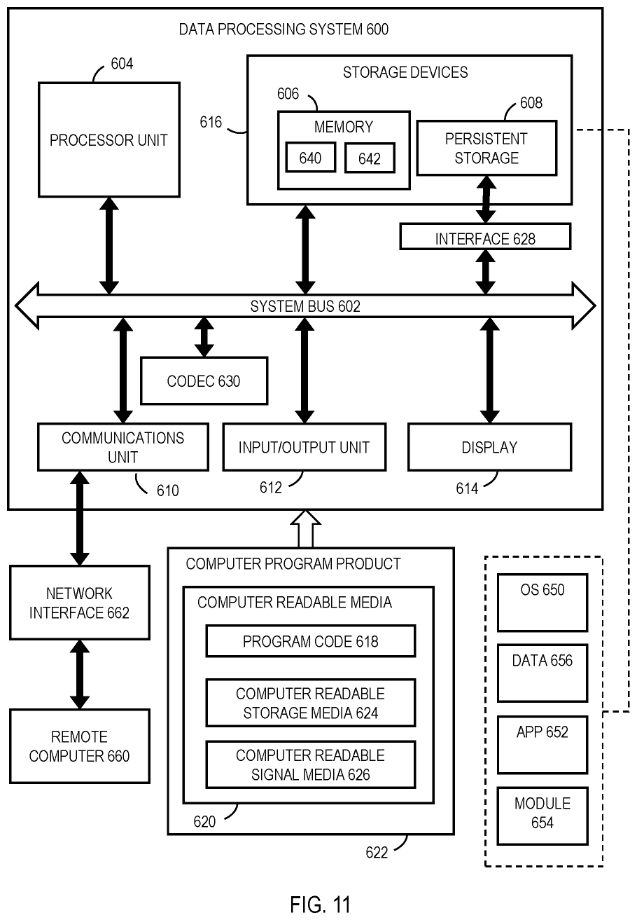

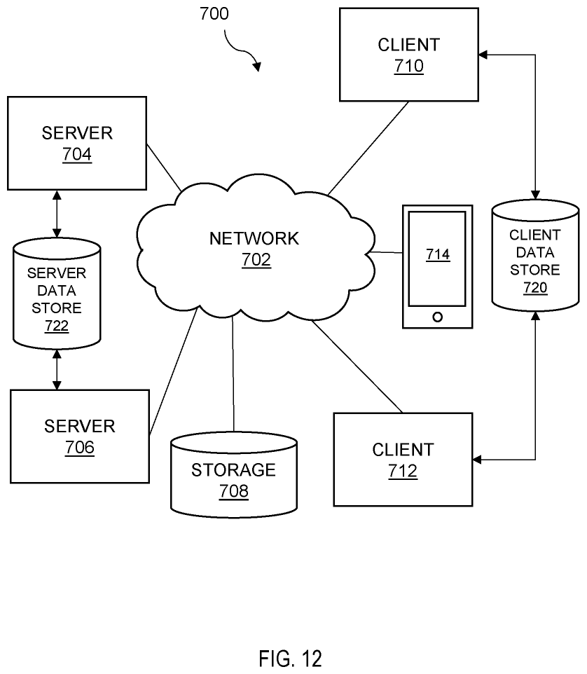

FIG. 10 is a flowchart illustrating steps performed in an illustrative method, and may not recite the complete process or all steps of the method. Although various steps of method 200 are described below and depicted in FIG. 10, the steps need not necessarily all be performed, and in some cases may be performed simultaneously or in a different order than the order shown.

Step 202 of method 200 includes receiving a user-submitted task at a learning system of the present disclosure. The task could take on any form, however it is expected that most tasks will be complex, subjective questions that require research and/or human opinions to answer. Tasks could also be actions that first require collaborative research. For example, experts may be required to perform a search for a missing person or thing, and/or may be requested to take a photo or video of a person, place or thing and transmit that photo or video to the user.

The task should have clear instructions and if any supporting electronic files are required, they should be small and easy to transmit, and should be scanned for viruses (which may also occur automatically by learning system 100's servers). Optional preprocessing may occur at this point.

Tasks may be structured with multiple elements or components, and learning system 100 is configured to distribute the task in an effective manner. For example, if the task is comprised of 16 questions or objectives, and if the input layer has eight expert nodes, then two items may be sent to each expert in the input layer.

Once the task and supporting files (if any) are submitted to learning system 100, a panel of experts (which may include experts for the selected network) may optionally review the task and offer suggestions to change the task if appropriate.

Step 204 of method 200 includes selecting a group of experts for the learning system. This may be performed automatically by learning system 100 after analyzing the task criteria, or it may performed manually and at the discretion of the user, who may specify selection criteria such as age, sex, location, education, income, experience, aptitude test results, previous task performance, accuracy, costs for performing tasks, and/or the like.

As part of the expert selection process, an offer price (if specified or required) for completing the task is provided to the experts, in addition to estimated time duration of the task, a full description of the task, and any imposed time limit or other pertinent information. Experts can decide to participate in the task or not. For example, each expert may accept, deny, or counteroffer. The counteroffer may provide an alternative start time, duration, or offer price. The user or the software may make the determination to accept or decline any counteroffer. After the selected number of experts has accepted the invitation, or after the user has determined that enough experts have accepted the invitation, processing may begin. The user may be notified of the progress starting, the estimated duration, etc., and may continuously receive updates on the task.

One or more expert participants who are not qualified (based on user criteria) may be selected and added to the network as a form of control sample to help ensure outputs are reliable. As experts confirm their interest and availability, learning system 100 may provide test questions so the experts can confirm their interest and ability to effectively participate in the task. Learning system 100 may provide the test questions or the user may provide the test questions.

If not enough qualified and interested experts are available to perform the task, learning system 100 may suggest an alternative and optimal time to attempt to re-run the task, e.g., based on availability and do-not-disturb times set by registered experts or by forecasting experts' availability based on past availability. The user may also modify selection criteria to find other experts or may try the task again at a later time.

Once the experts have been identified and committed to the task, and the task start time is known, a message may be shown or transmitted to the user indicating the estimated start time, cost, time to completion and other information about the task.

Step 206 of method 200 includes loading the expert settings for the chosen experts. Expert settings are loaded into the learning system (which may reside on servers and/or on computers or devices owned by experts or users) that will manage the task, including expert weights and various other settings, which may be loaded into a network layout. In some examples, a previously saved network may be loaded entirely, including expert IDs, weights for each expert, confidence levels, layout and various other settings to facilitate loading or reconstructing the same or similar network over again. In such examples, step 208 may be skipped.

Step 208 of method 200 includes determining a layout for the learning system. Learning system 100 may automatically determine the optimal layout (number of layers and number of experts per layer). In some examples, the user may specify the network layout. The network layout depends on the task complexity, the task elements including objectives, whether or not a training session will be conducted, and if so, the type of and number of training session tasks and outputs, and other factors.

Step 210 of method 200 includes processing the task using the learning system (e.g., after final approval by the user). For a more detailed description of this operation, see above.

Step 212 of method 200 includes notifying the user of the results. This may include one or more of the outputs from the experts as well as any accompanying files, media, data, etc.

### C. Illustrative Method for Training Hybrid Human-Computer Learning Systems

This section describes steps of an illustrative method 300 for training a hybrid human-computer learning system in accordance with aspects of the present disclosure; see FIG. 10. Aspects of the learning system described above may be utilized in the method steps described below. Where appropriate, reference may be made to components and systems that may be used in carrying out each step. These references are for illustration, and are not intended to limit the possible ways of carrying out any particular step of the method.

In general, training a neural network involves using an optimization algorithm to find an optimal set of weights. Before the network can be trained, it is initialized, which may entail creating an initial network layout, loading previously saved node weights, and modifying various settings and parameters.

Different algorithms exist to train neural networks, such as backpropagation, which is an iterative supervised learning algorithm that computes a gradient in order to adjust weights. Another model evolves polynomial neural networks by means of genetic algorithm, where the evaluation of weights is carried out simultaneously with architecture construction. Self-Organized Maps (Kohonen Networks) and other types of neural networks may be trained in various ways.

The learning system of the present disclosure may optimize its network architecture and weights in a way that rewards nodes that contribute the most valuable and timely output to the network. If training is performed, the training datasets are labeled and knowledge is transferred to the dataset so the network learns correlation between labels and data.

Learning system 100, the user, and/or a 3rd party may supply labeled training datasets to the network. The labels (also known as target values), which may be represented as text, drawings, photos, videos, recordings, calculations, forecasts, computer files or anything else that an expert might provide as a response or output) are assigned one or more values that range from −1 for incorrect to 1 for correct specifying the known output score (other ranges may be used). Experts may be presented with single or multiple choice correct and incorrect values from which to choose from.

FIG. 10 is a flowchart illustrating steps performed in an illustrative method, and may not recite the complete process or all steps of the method. Although various steps of method 300 are described below and depicted in FIG. 4, the steps need not necessarily all be performed, and in some cases may be performed simultaneously or in a different order than the order shown.

Step 302 of method 300 includes providing learning system 100 with a training dataset. The training dataset (AKA target values) may be fed into the network starting at the first layer or any other layer. Tasks may be sent to experts in each layer asynchronously or synchronously, at the discretion of the user or the learning system, which may run on a server or on a user's computer or device.

Step 304 of method 300 includes receiving outputs from the experts in the first layers. Experts in the first layer are presented with the tasks and are allowed a specific amount of time to process and submit a result, which is specified by the Task Time Limit user setting.

During training, experts in the first layers of the network may only be allowed to select from one of N predefined and labeled static outputs from the training sample (which are graded from −1 to 1 by correctness or by another range).

Step 306 of method 300 includes sending those experts' results through the subsequent layers for voting.

Step 308 of method 300 includes calculating error in learning system 100 and updating the weights of the experts. Error in learning system 100 may be calculated in one or more ways. In some examples, several error calculations may be utilized by learning system 100 in concert and/or sequentially.

For example, the difference of the expected output and the actual output of each expert may contribute to the expert's weight during training. For example, if the expert chooses an incorrect label that is scored −0.5, then 0.5% of the learning rate will be subtracted from the expert's weight.

Additionally, or alternatively, the difference between the overall output of learning system 100 and the expected output (i.e., target value) may be identified for the entire network. For example, if an average of all outputs may be 0.75 with respect to all labeled outputs, then 0.75% of the learning rate will be added to all experts' weights.

Additionally, or alternatively, if all confidence scores for all outputs are below an average of 50%, then the difference may be subtracted from all experts' weights. If above 50%, then add the difference to all weights: (1−0.5)*learning rate.

Additionally, or alternatively, errors in learning system 100 may be identified by comparing the number of final outputs to the number of expected outputs. In the case that the number of outputs is greater than the number of expected outputs, the network did not converge. In the case that the network did not converge, a compensation percentage may be subtracted from all weights, otherwise the compensating percentage may be added to all weights.

Optional step 310 of method 300 includes decreasing the Learning Rate if Simulated Annealing is enabled by the user and the Learning Rate is currently above 0%. The Learning Rate may be decreased by a set percentage of the current value (e.g., 10%). See previous section above for more information.

Optional step 312 of method 300 includes sending the outputs from the output layer back to the input layer for further processing. If this step is performed, the method returns to step 304, otherwise the method continues.

Optional step 314 of method 300 includes, sending the user a notification of the results, e.g. “the network gained 10% accuracy and is now 80% accurate after training.”

### D. Illustrative Data Processing System

As shown in FIG. 6, this example describes a data processing system 600 (also referred to as a computer, computing system, and/or computer system) in accordance with aspects of the present disclosure. In this example, data processing system 600 is an illustrative data processing system suitable for implementing aspects of the learning system and associated methods described above. More specifically, in some examples, devices that are embodiments of data processing systems (e.g., smartphones, tablets, personal computers) may host data pertaining to the learning system, execute one or more modules or software programs of the learning system, enable communication between users and experts of the learning system, and/or perform calculations and/or analysis on data retrieved, supplied, or generated by the learning system.

In this illustrative example, data processing system 600 includes a system bus 602 (also referred to as communications framework). System bus 602 may provide communications between a processor unit 604 (also referred to as a processor or processors), a memory 606, a persistent storage 608, a communications unit 610, an input/output (I/O) unit 612, a codec 630, and/or a display 614. Memory 606, persistent storage 608, communications unit 610, input/output (I/O) unit 612, display 614, and codec 630 are examples of resources that may be accessible by processor unit 604 via system bus 602.

Processor unit 604 serves to run instructions that may be loaded into memory 606. Processor unit 604 may comprise a number of processors, a multi-processor core, and/or a particular type of processor or processors (e.g., a central processing unit (CPU), graphics processing unit (GPU), etc.), depending on the particular implementation. Further, processor unit 604 may be implemented using a number of heterogeneous processor systems in which a main processor is present with secondary processors on a single chip. As another illustrative example, processor unit 604 may be a symmetric multi-processor system containing multiple processors of the same type.

Memory 606 and persistent storage 608 are examples of storage devices 616. A storage device may include any suitable hardware capable of storing information (e.g., digital information), such as data, program code in functional form, and/or other suitable information, either on a temporary basis or a permanent basis.

Storage devices 616 also may be referred to as computer-readable storage devices or computer-readable media. Memory 606 may include a volatile storage memory 640 and a non-volatile memory 642. In some examples, a basic input/output system (BIOS), containing the basic routines to transfer information between elements within the data processing system 600, such as during start-up, may be stored in non-volatile memory 642. Persistent storage 608 may take various forms, depending on the particular implementation.

Persistent storage 608 may contain one or more components or devices. For example, persistent storage 608 may include one or more devices such as a magnetic disk drive (also referred to as a hard disk drive or HDD), solid state disk (SSD), floppy disk drive, tape drive, Jaz drive, Zip drive, flash memory card, memory stick, and/or the like, or any combination of these. One or more of these devices may be removable and/or portable, e.g., a removable hard drive. Persistent storage 608 may include one or more storage media separately or in combination with other storage media, including an optical disk drive such as a compact disk ROM device (CD-ROM), CD recordable drive (CD-R Drive), CD rewritable drive (CD-RW Drive), and/or a digital versatile disk ROM drive (DVD-ROM). To facilitate connection of the persistent storage devices 608 to system bus 602, a removable or non-removable interface is typically used, such as interface 628.

Input/output (I/O) unit 612 allows for input and output of data with other devices that may be connected to data processing system 600 (i.e., input devices and output devices). For example, an input device may include one or more pointing and/or information-input devices such as a keyboard, a mouse, a trackball, stylus, touch pad or touch screen, microphone, joystick, game pad, satellite dish, scanner, TV tuner card, digital camera, digital video camera, web camera, and/or the like. These and other input devices may connect to processor unit 604 through system bus 602 via interface port(s). Suitable interface port(s) may include, for example, a serial port, a parallel port, a game port, and/or a universal serial bus (USB).

One or more output devices may use some of the same types of ports, and in some cases the same actual ports, as the input device(s). For example, a USB port may be used to provide input to data processing system 600 and to output information from data processing system 600 to an output device. One or more output adapters may be provided for certain output devices (e.g., monitors, speakers, and printers, among others) which require special adapters. Suitable output adapters may include, e.g. video and sound cards that provide a means of connection between the output device and system bus 602. Other devices and/or systems of devices may provide both input and output capabilities, such as remote computer(s) 660. Display 614 may include any suitable human-machine interface or other mechanism configured to display information to a user, e.g., a CRT, LED, or LCD monitor or screen, etc.

Communications unit 610 refers to any suitable hardware and/or software employed to provide for communications with other data processing systems or devices. While communication unit 610 is shown inside data processing system 600, it may in some examples be at least partially external to data processing system 600. Communications unit 610 may include internal and external technologies, e.g., modems (including regular telephone grade modems, cable modems, and DSL modems), ISDN adapters, and/or wired and wireless Ethernet cards, hubs, routers, etc. Data processing system 600 may operate in a networked environment, using logical connections to one or more remote computers 660. A remote computer(s) 660 may include a personal computer (PC), a server, a router, a network PC, a workstation, a microprocessor-based appliance, a peer device, a smart phone, a tablet, another network note, and/or the like. Remote computer(s) 660 typically include many of the elements described relative to data processing system 600. Remote computer(s) 660 may be logically connected to data processing system 600 through a network interface 662 which is connected to data processing system 600 via communications unit 610. Network interface 662 encompasses wired and/or wireless communication networks, such as local-area networks (LAN), wide-area networks (WAN), and cellular networks. LAN technologies may include Fiber Distributed Data Interface (FDDI), Copper Distributed Data Interface (CDDI), Ethernet, Token Ring, and/or the like. WAN technologies include point-to-point links, circuit switching networks (e.g., Integrated Services Digital networks (ISDN) and variations thereon), packet switching networks, and Digital Subscriber Lines (DSL).

Codec 630 may include an encoder, a decoder, or both, comprising hardware, software, or a combination of hardware and software. Codec 630 may include any suitable device and/or software configured to encode, compress, and/or encrypt a data stream or signal for transmission and storage, and to decode the data stream or signal by decoding, decompressing, and/or decrypting the data stream or signal (e.g., for playback or editing of a video). Although codec 630 is depicted as a separate component, codec 630 may be contained or implemented in memory, e.g., non-volatile memory 642.

Non-volatile memory 642 may include read only memory (ROM), programmable ROM (PROM), electrically programmable ROM (EPROM), electrically erasable programmable ROM (EEPROM), flash memory, and/or the like, or any combination of these. Volatile memory 640 may include random access memory (RAM), which may act as external cache memory. RAM may comprise static RAM (SRAM), dynamic RAM (DRAM), synchronous DRAM (SDRAM), double data rate SDRAM (DDR SDRAM), enhanced SDRAM (ESDRAM), and/or the like, or any combination of these.

Instructions for the operating system, applications, and/or programs may be located in storage devices 616, which are in communication with processor unit 604 through system bus 602. In these illustrative examples, the instructions are in a functional form in persistent storage 608. These instructions may be loaded into memory 606 for execution by processor unit 604. Processes of one or more embodiments of the present disclosure may be performed by processor unit 604 using computer-implemented instructions, which may be located in a memory, such as memory 606.

These instructions are referred to as program instructions, program code, computer usable program code, or computer-readable program code executed by a processor in processor unit 604. The program code in the different embodiments may be embodied on different physical or computer-readable storage media, such as memory 606 or persistent storage 608. Program code 618 may be located in a functional form on computer-readable media 620 that is selectively removable and may be loaded onto or transferred to data processing system 600 for execution by processor unit 604. Program code 618 and computer-readable media 620 form computer program product 622 in these examples. In one example, computer-readable media 620 may comprise computer-readable storage media 624 or computer-readable signal media 626.

Computer-readable storage media 624 may include, for example, an optical or magnetic disk that is inserted or placed into a drive or other device that is part of persistent storage 608 for transfer onto a storage device, such as a hard drive, that is part of persistent storage 608. Computer-readable storage media 624 also may take the form of a persistent storage, such as a hard drive, a thumb drive, or a flash memory, that is connected to data processing system 600. In some instances, computer-readable storage media 624 may not be removable from data processing system 600.

In these examples, computer-readable storage media 624 is a non-transitory, physical or tangible storage device used to store program code 618 rather than a medium that propagates or transmits program code 618. Computer-readable storage media 624 is also referred to as a computer-readable tangible storage device or a computer-readable physical storage device. In other words, computer-readable storage media 624 is media that can be touched by a person.

Alternatively, program code 618 may be transferred to data processing system 600, e.g., remotely over a network, using computer-readable signal media 626. Computer-readable signal media 626 may be, for example, a propagated data signal containing program code 618. For example, computer-readable signal media 626 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 618 may be downloaded over a network to persistent storage 608 from another device or data processing system through computer-readable signal media 626 for use within data processing system 600. For instance, program code stored in a computer-readable storage medium in a server data processing system may be downloaded over a network from the server to data processing system 600. The computer providing program code 618 may be a server computer, a client computer, or some other device capable of storing and transmitting program code 618.

In some examples, program code 618 may comprise an operating system (OS) 650. Operating system 650, which may be stored on persistent storage 608, controls and allocates resources of data processing system 600. One or more applications 652 take advantage of the operating system's management of resources via program modules 654, and program data 656 stored on storage devices 616. OS 650 may include any suitable software system configured to manage and expose hardware resources of computer 600 for sharing and use by applications 652. In some examples, OS 650 provides application programming interfaces (APIs) that facilitate connection of different type of hardware and/or provide applications 652 access to hardware and OS services. In some examples, certain applications 652 may provide further services for use by other applications 652, e.g., as is the case with so-called “middleware.” Aspects of present disclosure may be implemented with respect to various operating systems or combinations of operating systems.

The different components illustrated for data processing system 600 are not meant to provide architectural limitations to the manner in which different embodiments may be implemented. One or more embodiments of the present disclosure may be implemented in a data processing system that includes fewer components or includes components in addition to and/or in place of those illustrated for computer 600. Other components shown in FIG. 6 can be varied from the examples depicted. Different embodiments may be implemented using any hardware device or system capable of running program code. As one example, data processing system 600 may include organic components integrated with inorganic components and/or may be comprised entirely of organic components (excluding a human being). For example, a storage device may be comprised of an organic semiconductor.

In some examples, processor unit 604 may take the form of a hardware unit having hardware circuits that are specifically manufactured or configured for a particular use, or to produce a particular outcome or progress. This type of hardware may perform operations without needing program code 618 to be loaded into a memory from a storage device to be configured to perform the operations. For example, processor unit 604 may be a circuit system, an application specific integrated circuit (ASIC), a programmable logic device, or some other suitable type of hardware configured (e.g., preconfigured or reconfigured) to perform a number of operations. With a programmable logic device, for example, the device is configured to perform the number of operations and may be reconfigured at a later time. Examples of programmable logic devices include, a programmable logic array, a field programmable logic array, a field programmable gate array (FPGA), and other suitable hardware devices. With this type of implementation, executable instructions (e.g., program code 618) may be implemented as hardware, e.g., by specifying an FPGA configuration using a hardware description language (HDL) and then using a resulting binary file to (re)configure the FPGA.

In another example, data processing system 600 may be implemented as an FPGA-based (or in some cases ASIC-based), dedicated-purpose set of state machines (e.g., Finite State Machines (FSM)), which may allow critical tasks to be isolated and run on custom hardware. Whereas a processor such as a CPU can be described as a shared-use, general purpose state machine that executes instructions provided to it, FPGA-based state machine(s) are constructed for a special purpose, and may execute hardware-coded logic without sharing resources. Such systems are often utilized for safety-related and mission-critical tasks.

In still another illustrative example, processor unit 604 may be implemented using a combination of processors found in computers and hardware units. Processor unit 604 may have a number of hardware units and a number of processors that are configured to run program code 618. With this depicted example, some of the processes may be implemented in the number of hardware units, while other processes may be implemented in the number of processors.

In another example, system bus 602 may comprise one or more buses, such as a system bus or an input/output bus. Of course, the bus system may be implemented using any suitable type of architecture that provides for a transfer of data between different components or devices attached to the bus system. System bus 602 may include several types of bus structure(s) including memory bus or memory controller, a peripheral bus or external bus, and/or a local bus using any variety of available bus architectures (e.g., Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI)).

Additionally, communications unit 610 may include a number of devices that transmit data, receive data, or both transmit and receive data. Communications unit 610 may be, for example, a modem or a network adapter, two network adapters, or some combination thereof. Further, a memory may be, for example, memory 606, or a cache, such as that found in an interface and memory controller hub that may be present in system bus 602.

### E. Illustrative Distributed Data Processing System

As shown in FIG. 7, this example describes a general network data processing system 700, interchangeably termed a computer network, a network system, a distributed data processing system, or a distributed network, aspects of which may be included in one or more illustrative embodiments of the learning system and/or associated methods described above. For example, communication between nodes of the learning system may be enabled by and/or organized as an embodiment of network system 700.

It should be appreciated that FIG. 7 is provided as an illustration of one implementation and is not intended to imply any limitation with regard to environments in which different embodiments may be implemented. Many modifications to the depicted environment may be made.

Network system 700 is a network of devices (e.g., computers), each of which may be an example of data processing system 600, and other components. Network data processing system 700 may include network 702, which is a medium configured to provide communications links between various devices and computers connected within network data processing system 700. Network 702 may include connections such as wired or wireless communication links, fiber optic cables, and/or any other suitable medium for transmitting and/or communicating data between network devices, or any combination thereof.

In the depicted example, a first network device 704 and a second network device 706 connect to network 702, as do one or more computer-readable memories or storage devices 708. Network devices 704 and 706 are each examples of data processing system 600, described above. In the depicted example, devices 704 and 706 are shown as server computers, which are in communication with one or more server data store(s) 722 that may be employed to store information local to server computers 704 and 706, among others. However, network devices may include, without limitation, one or more personal computers, mobile computing devices such as personal digital assistants (PDAs), tablets, and smartphones, handheld gaming devices, wearable devices, tablet computers, routers, switches, voice gates, servers, electronic storage devices, imaging devices, media players, and/or other networked-enabled tools that may perform a mechanical or other function. These network devices may be interconnected through wired, wireless, optical, and other appropriate communication links.

In addition, client electronic devices 710 and 712 and/or a client smart device 714, may connect to network 702. Each of these devices is an example of data processing system 600, described above regarding FIG. 6. Client electronic devices 710, 712, and 714 may include, for example, one or more personal computers, network computers, and/or mobile computing devices such as personal digital assistants (PDAs), smart phones, handheld gaming devices, wearable devices, and/or tablet computers, and the like. In the depicted example, server 704 provides information, such as boot files, operating system images, and applications to one or more of client electronic devices 710, 712, and 714. Client electronic devices 710, 712, and 714 may be referred to as “clients” in the context of their relationship to a server such as server computer 704. Client devices may be in communication with one or more client data store(s) 720, which may be employed to store information local to the clients (e,g., cookie(s) and/or associated contextual information). Network data processing system 700 may include more or fewer servers and/or clients (or no servers or clients), as well as other devices not shown.

In some examples, first client electric device 710 may transfer an encoded file to server 704. Server 704 can store the file, decode the file, and/or transmit the file to second client electric device 712. In some examples, first client electric device 710 may transfer an uncompressed file to server 704 and server 704 may compress the file. In some examples, server 704 may encode text, audio, and/or video information, and transmit the information via network 702 to one or more clients.

Client smart device 714 may include any suitable portable electronic device capable of wireless communications and execution of software, such as a smartphone or a tablet. Generally speaking, the term “smartphone” may describe any suitable portable electronic device configured to perform functions of a computer, typically having a touchscreen interface, Internet access, and an operating system capable of running downloaded applications. In addition to making phone calls (e.g., over a cellular network), smartphones may be capable of sending and receiving emails, texts, and multimedia messages, accessing the Internet, and/or functioning as a web browser. Smart devices (e.g., smartphones) may include features of other known electronic devices, such as a media player, personal digital assistant, digital camera, video camera, and/or global positioning system. Smart devices (e.g., smartphones) may be capable of connecting with other smart devices, computers, or electronic devices wirelessly, such as through near field communications (NFC), BLUETOOTH®, WiFi, or mobile broadband networks. Wireless connectively may be established among smart devices, smartphones, computers, and/or other devices to form a mobile network where information can be exchanged.

Data and program code located in system 700 may be stored in or on a computer-readable storage medium, such as network-connected storage device 708 and/or a persistent storage 608 of one of the network computers, as described above, and may be downloaded to a data processing system or other device for use. For example, program code may be stored on a computer-readable storage medium on server computer 704 and downloaded to client 710 over network 702, for use on client 710. In some examples, client data store 720 and server data store 722 reside on one or more storage devices 708 and/or 608.

Network data processing system 700 may be implemented as one or more of different types of networks. For example, system 700 may include an intranet, a local area network (LAN), a wide area network (WAN), or a personal area network (PAN). In some examples, network data processing system 700 includes the Internet, with network 702 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. In some examples, network 702 may be referred to as a “cloud.” In those examples, each server 704 may be referred to as a cloud computing node, and client electronic devices may be referred to as cloud consumers, or the like. FIG. 7 is intended as an example, and not as an architectural limitation for any illustrative embodiments.

### F. Illustrative Combinations and Additional Examples

This section describes additional aspects and features of learning systems, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A0. A data processing system for providing a solution to a user-supplied task, the data processing system comprising:

a memory;

one or more processors;

a plurality of instructions stored in the memory and executable by the one or more processors to:
receive task-related data corresponding to a selected task, wherein the task is identified with a selected domain of one or more domains of expertise;
from a plurality of experts, automatically select a first subset of experts associated with the selected domain and a second subset of experts associated with the selected domain;
communicate the task-related data to a plurality of first electronic devices, wherein each of the first electronic devices is associated with a respective one of the experts of the first subset;
receive from each of the experts of the first subset, via the first electronic devices, a respective task solution and an accompanying first confidence score;
generate a first set of task solutions based on the task solutions received from the experts of the first subset, sorted by the first confidence scores;
communicate the task-related data and the first set of task solutions to a plurality of second electronic devices, wherein each of the second electronic devices is associated with a respective one of the experts of the second subset;
receive from each of the experts of the second subset, via the second electronic devices, information indicating a respective selected solution chosen from the first set of task solutions and an accompanying second confidence score;
generate a second set of task solutions based on the information indicating the selected solutions, sorted by the second confidence scores;
generate a preliminary output based on the second set of task solutions; and
communicate a final output based on the preliminary output to a user interface.

A1. The system of paragraph A0, wherein the instructions are further executable to: automatically associate the plurality of experts with one or more of the domains of expertise.

A2. The system of paragraph A0 or A1, wherein the instructions are further executable to:

communicate the task-related data and the preliminary output to the plurality of first electronic devices;

receive from each of the experts in the first subset, via the first electronic devices, information indicating a respective selected solution chosen from the preliminary output and an accompanying third confidence score;

generate a third set of task solutions based on the information indicating the selected solutions received from the first electronic devices, sorted by the third confidence score;

communicate the task-related data and the third set of task solutions to the plurality of second electronic devices;

receive from each of the experts in the second subset, via the second electronic devices, information indicating a respective selected solution chosen from the third set of task solutions and an accompanying fourth confidence score;

generate a fourth set of task solutions based on the information indicating the selected solutions from the second electronic devices, sorted by the fourth confidence score;

update the preliminary output based at least on the fourth set of task solutions prior to communicating the final output to the user interface.

A3. The system of any one of paragraphs A0 through A2, wherein the instructions are further executable to:

automatically select a third subset of the experts categorized in the selected domain;

communicate the task-related data and the second set of task solutions to a plurality of third electronic devices, wherein each of the third electronic devices is associated with a respective one of the experts of the third subset;

receive from each of the experts of the third subset, via the third electronic devices, information indicating a respective selected solution chosen from the second set of task solutions and an accompanying third confidence score;

generate a third set of task solutions based on the information indicating the selected task solutions received from the third electronic devices, sorted by the third confidence score;

update the preliminary output based on the third set of task solutions prior to communicating the final output to the user interface.

A4. The system of any one of paragraphs A0 through A3, wherein generating the second set of task solutions based on the information indicating the selected solutions includes sorting the second set by an aggregation of the first confidence scores and the second confidence scores.

A5. The system of paragraph A4, wherein the aggregation of the first confidence scores and the second confidence scores includes calculating an average of a combination of the first confidence scores and the second confidence scores.

A6. The system of paragraph A5, wherein the first confidence scores and the second confidence score are percentages from 0% to 100%.

A7. The system of any one of paragraphs A0 through A6, wherein the instructions are further executable to:

automatically assign a respective weight to each expert, wherein the respective weight of each expert is determined using historical data regarding a performance of the respective expert.

A8. The system of paragraph A7, wherein the instructions are further executable to:

automatically remove experts from the first subset and second subset that have a respective weight below a selected threshold.

A9. The system of any one of paragraphs A0 through A8, wherein the final output includes only a single solution.

B0. A data processing system for providing a solution to a user-supplied task, the data processing system comprising:

a memory;

one or more processors;

a plurality of instructions stored in the memory and executable by the one or more processors to:
receive task-related data corresponding to a selected task, wherein the task is identified with a selected domain of one or more domains of expertise;
from a plurality of experts, automatically select a first subset of experts, one or more intermediate subsets of experts, and a final subset of experts, wherein each of the subsets of experts is associated with the selected domain;
communicate the task-related data to a plurality of first electronic devices, wherein each of the first electronic devices is associated with a respective one of the experts of the first subset;
receive from each of the experts of the first subset, via the first electronic devices, a respective task solution and an accompanying first confidence score;
generate an intermediate set of task solutions based on the task solutions received from the experts of the first subset, sorted by the first confidence scores;
with respect to each of the one or more intermediate subsets, in series:
   communicate the task-related data and the intermediate set of task solutions to a plurality of electronic devices, wherein each of the electronic devices is associated with a respective one of the experts of the respective intermediate subset;
   receive from each of the experts of the respective intermediate subset, via the electronic devices, information indicating a respective selected solution chosen from the intermediate set of task solutions and an accompanying intermediate confidence score; and
   update the intermediate set of task solutions based on the information indicating the selected solutions, sorted by the intermediate confidence scores;
communicate the intermediate task-related data to a plurality of final electronic devices, wherein each of the final electronic devices is associated with a respective one of the experts of the final subset;
receive from each of the experts of the final subset, via the final electronic devices, information indicating a respective selected solution chosen from the intermediate set of task solutions and an accompanying final confidence score; and
communicate, to a user interface, a final set of task solutions based on the information indicating the selected solutions.

B1. The system of paragraph B0, wherein the final set of task solutions includes only a single solution.

B2. The system of paragraph B0 or B1, wherein the final set of task solutions is sorted by an aggregation of the first confidence scores, the intermediate confidence scores, and the final confidence scores.

B3. The system of paragraph B2, wherein the aggregation of the first confidence scores, the intermediate confidence scores, and the final confidence scores is determined by calculating an average of a combination of the first confidence scores, the intermediate confidence scores, and the final confidence scores.

B4. The system of any one of paragraphs B0 through B3, wherein the instructions are further executable to: automatically assign a respective weight to each expert, wherein the respective weight of each expert is determined using historical data regarding a performance of the respective expert.

B5. The system of paragraph B4, wherein the instructions are further executable to: automatically remove experts from the first subset, the one or more intermediate subsets, and the final subset that have a respective weight below a selected threshold.

B6. The system of any one of paragraphs B0 through B5, wherein the instructions are further executable to: automatically preprocess the task-related data prior to communicating the task-related data to the plurality of first electronic devices.

B7. The system of claim B6, wherein preprocessing the task-related data comprises encrypting portions of the task-related data.

B8. The system of any one of paragraphs B0 through B7, wherein the first confidence scores, the intermediate confidence scores, and the final confidence scores are percentages ranging from 0% to 100%.

B9. The system of any one of paragraphs B0 through B8, wherein one or more of the electronic devices comprises a mobile device.

### Advantages, Features, and Benefits

The different embodiments and examples of the learning system described herein provide several advantages over known solutions for solving difficult and/or subjective problems. For example, illustrative embodiments and examples described herein allow for solutions to problems outside of the scope of traditional computational methods.

Additionally, and among other benefits, illustrative embodiments and examples described herein allow a network of trained experts to collectively and efficiently provide a solution to a user submitted task.

Additionally, and among other benefits, illustrative embodiments and examples described herein allow a network of trained experts to collectively and efficiently provide a solution to a user submitted task with automatic peer review.

No known system or device can perform these functions. However, not all embodiments and examples described herein provide the same advantages or the same degree of advantage.

### Conclusion

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A data processing system for providing a solution to a user-supplied task, the data processing system comprising:
a memory;
one or more processors;
a plurality of instructions stored in the memory and executable by the one or more processors to:
receive task-related data corresponding to a selected task, wherein the task is identified with a selected domain of one or more domains of expertise;
from a plurality of experts, automatically select a first subset of experts associated with the selected domain and a second subset of experts associated with the selected domain;
communicate the task-related data to a plurality of first electronic devices, wherein each of the first electronic devices is associated with a respective one of the experts of the first subset;
receive from each of the experts of the first subset, via the first electronic devices, a respective task solution and an accompanying first confidence score;
generate a first set of task solutions based on the task solutions received from the experts of the first subset, sorted by the first confidence scores;
communicate the task-related data and the first set of task solutions to a plurality of second electronic devices, wherein each of the second electronic devices is associated with a respective one of the experts of the second subset;
receive from each of the experts of the second subset, via the second electronic devices, information indicating a respective selected solution chosen from the first set of task solutions and an accompanying second confidence score;
generate a second set of task solutions based on the information indicating the selected solutions, sorted by the second confidence scores;
generate a preliminary output based on the second set of task solutions; and
communicate a final output based on the preliminary output to a user interface.

2. The system of claim 1, wherein the instructions are further executable to:
automatically associate the plurality of experts with one or more of the domains of expertise.

3. The system of claim 1, wherein the instructions are further executable to:
communicate the task-related data and the preliminary output to the plurality of first electronic devices;
receive from each of the experts in the first subset, via the first electronic devices, information indicating a respective selected solution chosen from the preliminary output and an accompanying third confidence score;
generate a third set of task solutions based on the information indicating the selected solutions received from the first electronic devices, sorted by the third confidence score;
communicate the task-related data and the third set of task solutions to the plurality of second electronic devices;
receive from each of the experts in the second subset, via the second electronic devices, information indicating a respective selected solution chosen from the third set of task solutions and an accompanying fourth confidence score;
generate a fourth set of task solutions based on the information indicating the selected solutions from the second electronic devices, sorted by the fourth confidence score;
update the preliminary output based at least on the fourth set of task solutions prior to communicating the final output to the user interface.

4. The system of claim 1, wherein the instructions are further executable to:
automatically select a third subset of the experts categorized in the selected domain;
communicate the task-related data and the second set of task solutions to a plurality of third electronic devices, wherein each of the third electronic devices is associated with a respective one of the experts of the third subset;
receive from each of the experts of the third subset, via the third electronic devices, information indicating a respective selected solution chosen from the second set of task solutions and an accompanying third confidence score;
generate a third set of task solutions based on the information indicating the selected task solutions received from the third electronic devices, sorted by the third confidence score;
update the preliminary output based on the third set of task solutions prior to communicating the final output to the user interface.

5. The system of claim 1, wherein generating the second set of task solutions based on the information indicating the selected solutions includes sorting the second set by an aggregation of the first confidence scores and the second confidence scores.

6. The system of claim 5, wherein the aggregation of the first confidence scores and the second confidence scores includes calculating an average of a combination of the first confidence scores and the second confidence scores.

7. The system of claim 6, wherein the first confidence scores and the second confidence score are percentages from 0% to 100%.

8. The system of claim 1, wherein the instructions are further executable to:
automatically assign a respective weight to each expert, wherein the respective weight of each expert is determined using historical data regarding a performance of the respective expert.

9. The system of claim 8, wherein the instructions are further executable to:
automatically remove experts from the first subset and second subset that have a respective weight below a selected threshold.

10. The system of claim 1, wherein the final output includes only a single solution.

11. A data processing system for providing a solution to a user-supplied task, the data processing system comprising:
a memory;
one or more processors;
a plurality of instructions stored in the memory and executable by the one or more processors to:
receive task-related data corresponding to a selected task, wherein the task is identified with a selected domain of one or more domains of expertise;
from a plurality of experts, automatically select a first subset of experts, one or more intermediate subsets of experts, and a final subset of experts, wherein each of the subsets of experts is associated with the selected domain;
automatically assign a respective weight to each expert of the plurality of experts, wherein the respective weight of each expert is determined using historical performance data of the respective expert;
communicate the task-related data to a plurality of first electronic devices, wherein each of the first electronic devices is associated with a respective one of the experts of the first subset;
receive from each of the experts of the first subset of experts, via the first electronic devices, a respective subjective response and an accompanying first confidence score indicating a confidence of the respective expert in the subjective response;
generate an intermediate set of task solutions based on the subjective responses received from the experts of the first subset of experts, sorted by the first confidence scores;
with respect to each of the one or more intermediate subsets of experts, in series:
communicate the task-related data and the intermediate set of task solutions to a plurality of electronic devices, wherein each of the electronic devices is associated with a respective one of the experts of the respective intermediate subset of experts;
receive from each of the experts of the respective intermediate subset of experts, via the electronic devices, information indicating a respective selected solution chosen from the intermediate set of task solutions and an accompanying intermediate confidence score; and
update the intermediate set of task solutions based on the information indicating the selected solutions, sorted by the intermediate confidence scores;
communicate the intermediate task-related data to a plurality of final electronic devices, wherein each of the final electronic devices is associated with a respective one of the experts of the final subset of experts;
receive from each of the experts of the final subset of experts, via the final electronic devices, information indicating a respective selected solution chosen from the intermediate set of task solutions and an accompanying final confidence score; and
communicate, to a user interface, a final set of task solutions based on the information indicating the selected solutions.

12. The system of claim 11, wherein the final set of task solutions includes only a single solution.

13. The system of claim 11, wherein the final set of task solutions is sorted by an aggregation of the first confidence scores, the intermediate confidence scores, and the final confidence scores.

14. The system of claim 13, wherein the aggregation of the first confidence scores, the intermediate confidence scores, and the final confidence scores is determined by calculating an average of a combination of the first confidence scores, the intermediate confidence scores, and the final confidence scores.

15. (canceled)

16. The system of claim 11, wherein the instructions are further executable to:
automatically remove experts from the first subset, the one or more intermediate subsets, and the final subset that have a respective weight below a selected threshold.

17. The system of claim 11, wherein the instructions are further executable to:
automatically preprocess the task-related data prior to communicating the task-related data to the plurality of first electronic devices.

18. The system of claim 17, wherein preprocessing the task-related data comprises encrypting portions of the task-related data.

19. The system of claim 11, wherein the first confidence scores, the intermediate confidence scores, and the final confidence scores are percentages ranging from 0% to 100%.

20. The system of claim 11, wherein one or more of the electronic devices comprises a mobile device.
